(19) United States
(12) Patent Application Publication
(10) Pub. No.: US 2017/0111414 A1
(43) Pub. Date: Apr. 20, 2017

(54) VIDEO PLAYING METHOD AND DEVICE

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Peng CANG, Tianjin (CN)

(21) Appl. No.: 15/244,851

(22) Filed: Aug. 23, 2016

Related U.S. Application Data
(63) Continuation of application No. PCT/CN2016/088895, filed on Jul. 6, 2016.

(30) Foreign Application Priority Data
Oct. 16, 2015 (CN) 201510672124.9

(51) Int. Cl. H04L 29/06; H04L 12/925

(52) U.S. Cl. CPC H04L 65/4069; H04L 47/722; H04L 67/2847

(57) ABSTRACT

Embodiments of the present disclosure disclose a video playing method and device. The method comprises the following steps: a player in a playing page obtains a storage address of a target video when the playing page is loaded; a playing component for the target video is determined by analyzing the storage address; a data packet of the target video is obtained according to the storage address; the playing component is used to process the obtained data packet to generate buffered data; the target video is played according to the buffered data if a playing command is detected after the completion of loading the playing page. According to the video playing method and device, when the playing page is loaded, the player may be activated to obtain the data packet of the target video in advance, and the playing component is created

### CROSS-REFERENCE TO RELATED APPLICATIONS

This application is a continuation of International Application No. PCT/CN2016/088895 filed on Jul. 6, 2016, which is based upon and claims priority to Chinese Patent Application No. 201510672124.9, entitled “VIDEO PLAYING METHOD AND DEVICE”, filed on Oct. 16, 2015, the entire contents of all of which are incorporated herein by reference.

### TECHNICAL FIELD

The present disclosure generally relates to the technical field of videos, and in particular relates to a video playing method and a video playing device.

### BACKGROUND

With the rapid development of the network techniques, many service platforms play network videos by means of players to provide diversified services. For example, the service platforms may play news, TV dramas, films, and animations by means of webpage players.

During implementing the invention, the inventor found that, usually, before playing a network video, it needs to analyze a streaming media transmission protocol, buffer part of video data for analysis, and create a demultiplexer and an audio decoder. Hence, when playing a video, preparation time, i.e., playing starting time, is required for a player. The shorter the playing starting time is, the better the experience brought for a user is.

However, at present, when a user wants to watch a network video, a player only can be activated to obtain video data for analysis before playing after the user clicks the playing button of the player or sends other instruction information as required; therefore, after sending the instructions, the user needs to wait for some time before watching the video contents of the network video. This causes waste of time and relatively low playing efficiency.

### SUMMARY

The technical problems to be solved by embodiments of the present disclosure is to provide a video playing method to reduce the time of a user waiting for video loading and improve the playing efficiency.

Accordingly, the embodiments of the present disclosure also provide a video playing device that is used to guarantee the implementation and application of the above method.

According to one aspect of the present disclosure, the embodiments of the present disclosure provide a video playing method, including the following steps:

at an electronic device,

a player in a playing page obtaining a storage address of a target video when the playing page is loaded;

determining a playing component for the target video by analyzing the storage address;

obtaining a data packet of the target video according to the storage address;

using the playing component to process the obtained data packet to generate buffered data;

playing the target video according to the buffered data if a playing command is detected after the completion of loading the playing page.

Accordingly, according to another aspect of the present disclosure, the embodiments of the present disclosure also provide an electronic device for video playing, including: at least one processor; and a memory communicably connected with the at least one processor for storing instructions executable by the at least one processor, wherein execution of the instructions by the at least one processor causes the at least one processor to:

enable a player in a playing page to obtain a storage address of a target video when the playing page is loaded;

determine a playing component for the target video by analyzing the storage address;

obtain a data packet of the target video according to the storage address;

use the playing component to process the obtained data packet to generate buffered data;

play the target video according to the buffered data if a playing command is detected after the completion of loading the playing page.

According to further another aspect of the present disclosure, provided is a non-transitory computer readable medium storing executable instructions that, when executed by an electronic device, cause the electronic device to: obtain a storage address of a target video by a player in a playing page when the playing page is loaded; determine a playing component for the target video by analyzing the storage address; obtain a data packet of the target video according to the storage address; use the playing component to process the obtained data packet to generate buffered data; and play the target video according to the buffered data if a playing command is detected after the completion of loading the playing page.

Compared with the prior art, the embodiments of the present disclosure have the following advantages:

in the embodiments of the present disclosure, before a playing command is received, the data packet of a target video can be obtained by means of the storage address of the target video, and then the data packet is processed to generate buffered data. Upon detecting the playing command, the target video can be played according to the buffered data. Thus, the time of a user waiting for video loading is reduced, and the playing efficiency is improved.

The above descriptions are merely the summary of the technical solutions of the present disclosure. In order to know the technical means of the present disclosure more clearly, implementation can be carried out according to the contents of the description. Additionally, in order to make the above and other objectives, features and advantages of the present disclosure more obvious and understandable, specific embodiments of the present disclosure are described below.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flow diagram of a video playing method in accordance with some embodiments.

FIG. 2 is a step flow diagram of a video playing method in accordance with some embodiments.

FIG. 3 is a structural block diagram of a video playing device in accordance with some embodiments.

FIG. 4 is a structural block diagram of a video playing device in accordance with some embodiments.

FIG. 5 exemplarily shows a block diagram of an electronic device for executing a method according to the present disclosure.

FIG. 6 exemplarily shows a storage unit for holding or carrying program codes for implementing a method according to the present disclosure.

### DESCRIPTION OF THE EMBODIMENTS

In order to make the objectives, technical solutions and advantages of the embodiments of the present disclosure more clear, the technical solutions in the embodiments of the present disclosure will be described below clearly and completely in conjunction with the accompanying drawings in the embodiments of the present disclosure. Obviously, the described embodiments are part of embodiments of the present disclosure, not all embodiments. On the basis of the embodiments in the present disclosure, all the other embodiments obtained by people ordinarily skilled in the art without creative labor should fall into the scope of protection of the present disclosure.

With the development of modern technologies, networks bring people information in diversified forms. From the first picture appearing on the networks to now network videos and three-dimensional animations in various forms, networks make people obtain great satisfaction in seeing and hearing. For transmitting multimedia information such as audios, videos or the like on networks, a user usually may directly access the Internet to watch videos. In other words, stream transmission multimedia is adopted to play videos, i.e., streaming media display videos. Streaming media are continuous time-based media using the stream transmission technology in the Internet, for example, audios, videos, or other multimedia documents.

The data streams of the streaming media have the characteristic that they can be transmitted at any time and played at any time. Specifically, before formally displaying a network video, a player requires enough preparation time for getting ready to play the network video. At present, a player is activated for preparation time typically after receiving a playing command input by a user, for example, after a playing button is clicked. In order to resist network jittering, the player also may buffer more video data to play the network video fluently, which leads to an increase in preparation time and reduction of the playing efficiency.

With regard to the above problem, one core concept of the embodiments of the present disclosure is as follows: when a playing page is loaded, a player can be pre-activated to obtain a data packet of a target video, and a playing component is created, which is used to analyze the data packet to generate buffered data. After the playing page is loaded completely, if a playing command is detected, the target video can be played according to the buffered data. In this way, the time of a user waiting for video loading is reduced, and the playing efficiency is improved.

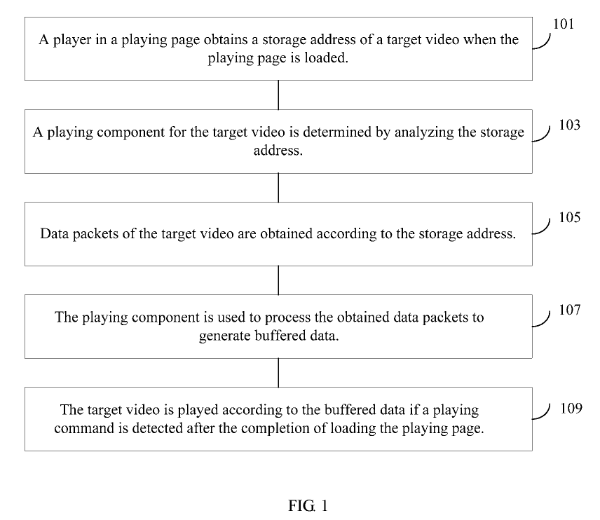

By referring to FIG. 1, illustrated is a step flow diagram of an embodiment of a video playing method of the present disclosure; the video playing method may specifically include the steps as follows.

Step 101, a player in a playing page obtains a storage address of a target video when the playing page is loaded.

In practice, a user can enter the playing interface of a chosen network video by means of an application or a webpage browser. Usually, after entering the playing interface of the network video, the user can get the content of the network video from the brief introduction of the network video or comments made by other users, i.e., stay in the playing interface of the chosen network video for a while.

When the user stays in the playing interface, apart from a small part of network bandwidth occupied by network page loading during this period, the rest network bandwidth is idle. Hence, when the playing interface is loaded, the idle network bandwidth can be used to pre-activate a player to obtain the storage address of the target video chosen by the user. That is to say, when the playing page is loaded, the player in the playing page is pre-activated to obtain the storage address of the target video. For example, when the playing interface is loaded, a video player can be activated directly. The interface setDataSource of the player is called to receive the storage address of the target video; equivalently, a method setDataSource( ) is called to obtain the URL (Uniform Resource Locator) of the target video.

It needs to be noted that the storage address may include such information as a streaming media transmission protocol, a server name (or an IP address), a path and a file name. The storage address may include the following two parts:

The first part is the streaming media transmission protocol, which may specify how a file to be opened is processed.

The streaming media transmission protocol may be one of such protocols as RTP (Real-time Transport Protocol), RTCP (Real-time Transport Control Protocol), RTSP (Real Time Streaming Protocol), RSV (Resource Reserve Protocol), and HLS (HTTP Live Streaming), which is not limited in the embodiments of the present disclosure.

Among the above protocols, RTP provides a time stamp, a sequence number, and any other method capable of ensuring processing time during real-time data transmission); RTCP is the control part of RTP, and used to ensure the quality of service and member management; RTSP hands over specific data transmission to RTP, and provides remote control on streams; RSVP reserves bandwidth to improve QOS (Quality Of Service); HLS is a streaming media transmission protocol based on HTTP (HyperText Transfer Protocol), and is capable of live broadcasting and on-demand broadcasting of streaming media.

The second part may include the name or the IP address of a server where a file is stored, as well as a path to the file and the name of the file.

Step 103, a playing component for the target video is determined by analyzing the storage address.

When the streaming media technology is used, audio-video files should be created in corresponding file formats. That is to say, different multimedia information may form different streaming media format files; different file formats require different playing components for playing, which is called opening different locks with different keys.

Among them, common streaming media formats may include sound streams, video streams, text streams, image streams, animation streams, etc. The file formats suitable for the streaming media technology may include such file formats as ASF (Advanced Streaming Format), MPEG (Moving Picture Experts Group), and AVI (Audio Video Interleaved), which is not limited in the embodiments of the present disclosure.

In this embodiment of the present disclosure, the streaming media transmission protocol by which the file of the target video is transmitted can be determined by analyzing the storage address. According to the streaming media transmission protocol, the file format of the target video, i.e., the video format, can be determined. On the basis of the video format, a playing component needed for playing the target video can be created. The playing component may include a demultiplexer and a decoder, wherein the demultiplexer is capable of separating the data streams of different streaming media in the target video file according to the streaming media formats, and the decoder is capable of decoding the data streams separated out to generate corresponding media playing data. The media playing data can be used to display the target video, i.e., play it.

In a preferred embodiment of the present disclosure, the step that the playing component for the target video is determined by analyzing the storage address includes the substeps as follows.

Substep 10301, the storage address is analyzed to determine the video format of the target video.

Substep 10303, the playing component required for playing the target video is created according to the video format.

Step 105, data packets of the target video are obtained according to the storage address.

On the basis of the storage address of the target video, access can be made to a media server where the target video is stored according to the name or the address of the server, and then the multimedia file of the target video can be obtained according to the path and the name of the file. Relevant multimedia data streams can be extracted from the multimedia file of the target video according to the determined streaming media transmission protocol, and the extracted multimedia data streams are formed into a plurality of data packets. One of these data packets may include a sound stream, a video stream, a text stream, an animation stream, etc. That is to say, each data packet may include one or more of such data streams as the audio data stream, the text data stream, and the video data stream. According to the streaming media transmission protocol, the data packets can be transmitted to the player of a client. In other words, the player may obtain the data packets of the target video according to the streaming media transmission protocol.

Step 107, the playing component is used to process the obtained data packets to generate buffered data.

After the player obtains the data, the playing component can be used to process the data packets to generate relevant data for playing the target video. Specifically, the demultiplexer can be used to process the data packets, namely separating multimedia data streams according to different multimedia data types. The decoder may decode the multimedia data streams separated by the demultiplexer to generate multimedia data that can be played. The player may save the multimedia data generated after decoding, namely generating the buffered data. The buffer data therein may include video data, animation data, audio data, and the like, which is not limited in the embodiments of the present disclosure.

In another preferred embodiment of the present disclosure, the playing component may include a demultiplexer and a decoder; the above step 107 that the playing component is used to process the obtained data packets to generate the buffered data may include the substeps as follows.

Substep 10701, the demultiplexer is used to separate the data packets to generate a video data stream and an audio data stream.

Substep 10702, the video data stream and the audio data stream are decoded by the decoder to generate the buffered data.

Step 109, the target video is played according to the buffered data if a playing command is detected after the completion of loading the playing page.

In fact, after the completion of loading the playing page, the player is ready for playing the target video, but may not directly play the target video. When a playing instruction input by a user is received, i.e., a playing command input by the user is detected, the target video is played according to the buffered data. Thus, the user can directly watch the chosen video after inputting the playing command. As a result, the playing efficiency of the player is improved, and the time of the user waiting for video loading is saved. For example, when the user clicks the playing page or the playing button of the player, the player may detect the playing command and play the buffered data by calling a playing method Start( ), namely playing the target video. The user can directly watch the video chosen to play after clicking the playing button, and therefore, the waiting time is saved.

Of course, the player may also generate more buffered data by using the idle network bandwidth before defecting the playing command of the user, thereby realizing fluent playing of the target video.

In the embodiments of the present disclosure, before loading a network page, a player can be directly activated and pre-activated. In the process when a user stays in the playing page, the player enters the stage of preparing for playing a video, namely analyzing the streaming media transmission protocol, and creating a playing component. The playing component is used to process the obtained data packets to generate multimedia data needed for playing the target video. As a result, the user can directly watch the video after inputting the playing instruction. The time of the user is saved while the playing efficiency is improved.

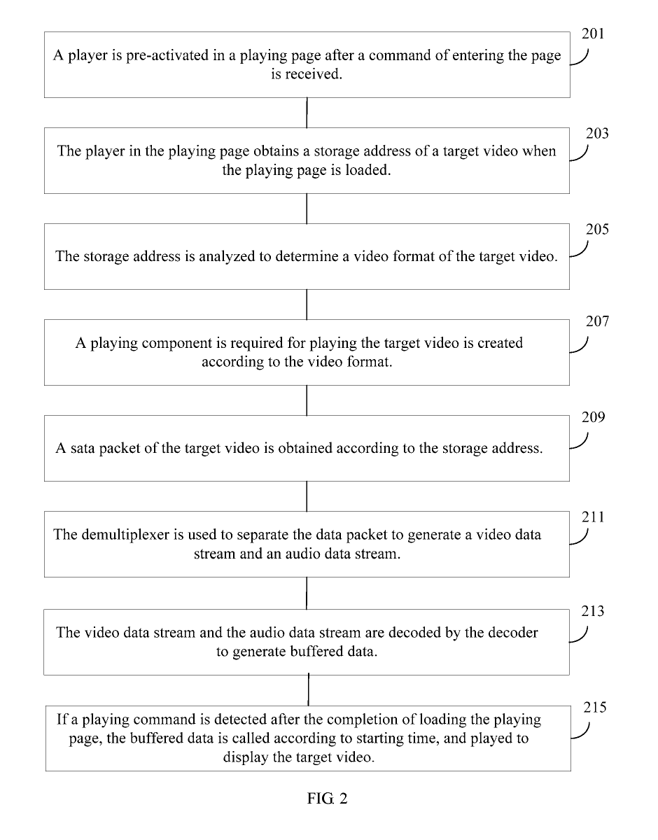

By referring to FIG. 2, illustrated is a step flow diagram of another embodiment of a video playing method of the present disclosure, and the video playing method may include the steps as follows.

Step 201, a player is pre-activated in a playing page after a command of entering the page is received.

Actually, a user may enter a playing interface of a network video via an application or a webpage browser. For example, the user opens a video watching webpage via the webpage browser. Specifically, an instruction of entering the page needs to be sent to a server to open the video watching page. For example, a webpage link is clicked to send an instruction of entering the webpage to the server. After receiving the command of entering the page, the server analyzes the command of entering the page, and responds to the command of entering the page, namely loading the page. If the page is a playing page, the player of the playing page is directly activated while the page is loaded.

Step 203, the player in the playing page obtains a storage address of a target video when the playing page is loaded.

In a preferred embodiment of the present disclosure, the step that the player in the playing page obtains a storage address of a target video when the playing page is loaded may include the following substeps.

Substep 20301, the target video is determined according to video information locally buffered or in the page command when the playing page is loaded.

The playing page may save historical records of a user watching videos to generate locally buffered data. For example, the watching records of the user are saved by means of webpage cookies. Hence, when the playing page is loaded, the last video that the user watches in the playing webpage can be determined according to the locally buffered data, and is regarded as the target video.

Of course, the user can also choose one video in the playing page, and the video chosen by the user is determined as the target video. For example, the user chooses a certain video by clicking the icon of the video. Choosing a video is equivalent to sending a command of choosing a target video; the command of choosing the target video may be understood as the page command of the playing page. Obviously, the playing page may also determine the target video according to the page command. The mode of determining the target video is not limited in the embodiments of the present disclosure.

Substep 20301, the player obtains the storage address of the target video that is transmitted by the playing page.

After the target video is determined, the playing page may transmit the storage address of the target video to the player. That is to say, the player may obtain the storage address transmitted by the playing page.

Step 205, the storage address is analyzed to determine a video format of the target video.

In practice, when streaming media are transmitted on networks, the transmitted files need to be made into streaming media format files suitable for streaming media transmission. Specifically, a file needing to be transmitted in a streaming media format should be preprocessed to generate a streaming media format file. That is to say, while streaming information is added to the file, the file is compressed by using an appropriate compression algorithm to generate the streaming media format file of smaller capacity.

The player may determine the video format of the target video by analyzing the storage address of the target. For example, the video format can be determined by means of the file extension of the multimedia file in which the target video is stored. By taking the MPEG format as an example, when the file extension of the multimedia file is MPEG or MPG, it may be sure that the video format of the target video is the MPEG format.

Step 207, a playing component is required for playing the target video is created according to the video format.

Multimedia files in different video formats may be generated by processing multimedia data using different software. The compression algorithm employed by the target video can be determined according to the video format. Hence, according to the determined video format, a creation method corresponding to the compression algorithm may be called to create the playing component. The playing component may include a demultiplexer and a decoder, wherein the demultiplexer may include an audio decoder and a video decoder. By taking the playing flow of the android system as an example, after an URL is received by means of interface setDataSource in Media Player, a playing component creation method may be called via interface PrepareAsync to create a corresponding playing component, such that Media Player may enter a preparation stage, namely preloading and buffering data. For example, demultiplexer Demux may be created by means of demultiplexer creation method finishSetDataSource_1( ); alternatively, a video decoder may be created by means of video decoder creation method initVideoDecoder( ); also, an audio decoder may be created by means of audio decoder creation method initAudioDecoder( ).

It needs to be noted that a person skilled in the art can realize the creation of the playing component by using different programming languages, such as Java language, assembly language, C language, and C++ language, which is not limited in the embodiments of the present disclosure.

Step 209, a data packet of the target video is obtained according to the storage address.

Step 211, the demultiplexer is used to separate the data packet to generate a video data stream and an audio data stream.

In fact, an audio and a video are coded independently in the making process, and therefore, separate multimedia data, namely audio data and video data, are obtained. For the sake of convenient transmission, the audio data and the video data are packaged together. In other words, a multimedia file is generated by using a pair of compression algorithms, such that the audio data and the video data can be transmitted together. Then, the data packet may include the audio data stream and the video data stream.

After the player obtains the data packet of the target video, the data packet may be decompressed by using a decompression algorithm of the playing component.

Step 213, the video data stream and the audio data stream are decoded by the decoder to generate buffered data.

When the playing component processes the data packet, the data packet may be unpacked by the demultiplexer, such that different multimedia data streams, namely the audio data stream and the video data stream of the data packet, can be separated. Moreover, the audio data stream and the video data stream generated after separation are sent to an audio decoder and a video decoder for decoding, respectively, thereby restoring the audio data and the video data.

In a preferred embodiment of the present disclosure, the decoder includes an audio decoder and a video decoder. The step that the video data stream and the audio data stream are decoded by the decoder to generate the buffered data may include the substeps as follows.

Substep 21301, the audio decoder is used to decode the audio data stream to generate the audio data.

Substep 21303, the video decoder is used to decode the video data stream to generate the video data.

Substep 21305, the audio data and the video data are combined to generate the buffered data.

In fact, the audio data and the video data need to be played simultaneously in accordance with a certain playing sequence. The player may combine the decoded audio data and video data to generate and save the relevant data for playing the video, namely generating the buffered data.

Step 215, if a playing command is detected after the completion of loading the playing page, the buffered data is called according to starting time, and played to display the target video.

Specifically, after the completion of loading the playing page, if a playing command from a user is detected, the player may play the buffered data. In this case, the video may be played from the beginning, or according to set starting time. For example, the player is preset to skip the beginning, which correspondingly lasts for 2 minutes, the buffered data can be called from the moment of 2 minutes to be played, thereby displaying the target video. For another example, a record is made to that the user watched before the video, and then the buffered data is called by taking the time point when the user stops last time as the starting time. Therefore, the time of the user waiting for video loading can be further reduced.

In the embodiments of the present disclosure, the player can be directly activated when the page is loaded to preload the target video, i.e., pre-generate the buffered data, by using the idle network bandwidth before receiving the playing command; thus, the waste of network resources is avoided. When the playing command is detected, the buffered data can be called according to a position of a slider on a progress bar, namely the starting time, such that the content of the video that a user wants to watch can be played directly. As a result, the playing efficiency of the player is improved while the network resources are saved, and the time of the user is saved.

It needs to be noted that the method embodiments, for the sake of simple descriptions, are all described as a series of action combinations. However, it should be known by a person skilled in the art that the embodiments of the present disclosure are not limited by the described action sequence, because some steps can be carried out in other sequences or simultaneously according to the embodiments of the present disclosure. For another, it should also be known by a person skilled in the art that the embodiments described in the description are all preferred embodiments, in which the actions involved are not always necessary for the embodiments of the present disclosure.

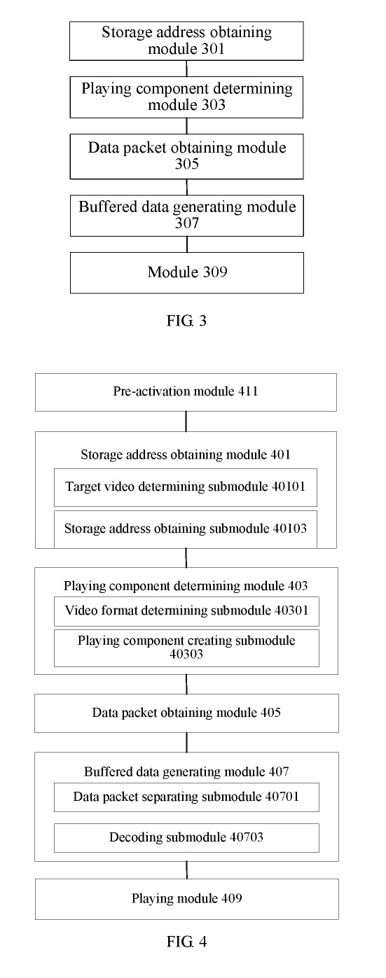

By referring to FIG. 3, illustrated is a structural block diagram of an embodiment of a video playing device of the present disclosure. The video playing device may specifically include the following modules:

a storage address obtaining module 301, which may be configured to enable a player in a playing page to obtain a storage address of a target video when the playing page is loaded;

a playing component determining module 303, which may be configured to determine a playing component for the target video by analyzing the storage address;

a data packet obtaining module 305, which may be configured to obtain a data packet of the target video according to the storage address;

a buffered data generating module 307, which may be configured to use the playing component to process the obtained data packet to generate buffered data;

a playing module 309, which may be configured to play the target video according to the buffered data if a playing command is detected after the completion of loading the playing page.

In the embodiments of the present disclosure, before loading a network page, a player can be directly activated and pre-activated. In the process when a user stays in the playing page, the player enters the stage of preparing for playing a video, namely analyzing the streaming media transmission protocol, and creating a playing component. The playing component is used to process the obtained data packets to generate multimedia data needed for playing the target video. As a result, the user can directly watch the video after inputting the playing instruction. The time of the user is saved while the playing efficiency is improved.

By referring to FIG. 4, illustrated is a structural block diagram of a preferred embodiment of a video playing device of the present disclosure. The video playing device may specifically include the following modules.

A storage address obtaining module 401 may be configured to enable a player in a playing page to obtain a storage address of a target video when the playing page is loaded.

In a preferred embodiment of the present disclosure, the storage address obtaining module 401 may include the following submodules:

a target video determining submodule 40101, configured to determine the target video according to video information locally buffered or in the page command when the playing page is loaded;

a storage address obtaining submodule 40103, configured to enable the player to obtain the storage address of the target video that is transmitted by the playing page.

A playing component determining module 403 may be configured to determine a playing component for the target video by analyzing the storage address.

In a preferred embodiment of the present disclosure, the playing component determining module 403 may include the following submodules:

a video format determining submodule 40301, which may be configured to analyze the storage address to determine a video format of the target video;

a playing component creating submodule 40303, which may be configured to create the playing component required for playing the target video according to the video format.

A data packet obtaining module 405 may be configured to obtain a data packet of the target video according to the storage address.

A buffered data generating module 407 may be configured to use the playing component to process the obtained data packet to generate buffered data.

In another preferred embodiment of the present disclosure, the playing component includes a demultiplexer and a decoder. The buffered data generating module 407 may include the following submodules:

a data packet separating submodule 40701, which may be configured to use the demultiplexer to separate the data packet to generate a video data stream and an audio data stream;

a decoding submodule 40703, which may be configured to decode the video data stream and the audio data stream by using the decoder to generate the buffered data.

In a preferred embodiment of the present disclosure, the decoder includes an audio decoder and a video decoder. The decoding submodule 40703 may include the followings:

an audio data generating unit 4070301, which may be configured to decode the audio data stream by using the audio decoder to generate audio data;

a video data generating unit 4070303, which may be configured to decode the video data stream by using the video decoder to generate video data;

a combination unit 4070305, which may be configured to combine the audio data and the video data to generate the buffered data.

A playing module 409 may be specifically configured to, if a playing command is detected after the completion of loading the playing, call the buffered data according to starting time, and play the buffered data to display the target video.

Optionally, the device may also include a pre-activation module 411.

The pre-activation module 411 is configured to pre-activate the player in the playing page after receiving a command of entering the page.

In the embodiments of the present disclosure, the player can be directly activated when the page is loaded to preload the target video, i.e., pre-generate the buffered data, by using the idle network bandwidth before receiving the playing command; thus, the waste of network resources is avoided. When the playing command is detected, the buffered data can be called according to a position of a slider on a progress bar, namely the starting time, such that the content of the video that a user wants to watch can be played directly. As a result, the playing efficiency of the player is improved while the network resources are saved, and the time of the user is saved.

The device embodiments are described simply because they are substantially similar to the method embodiments, and the relevant parts of the device embodiments just refer to the corresponding parts of the method embodiments.

Each embodiment in the description is described in a progressive manner. Descriptions emphasize on the differences of each embodiment from other embodiments, and same or similar parts of various embodiments just refer to each other.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

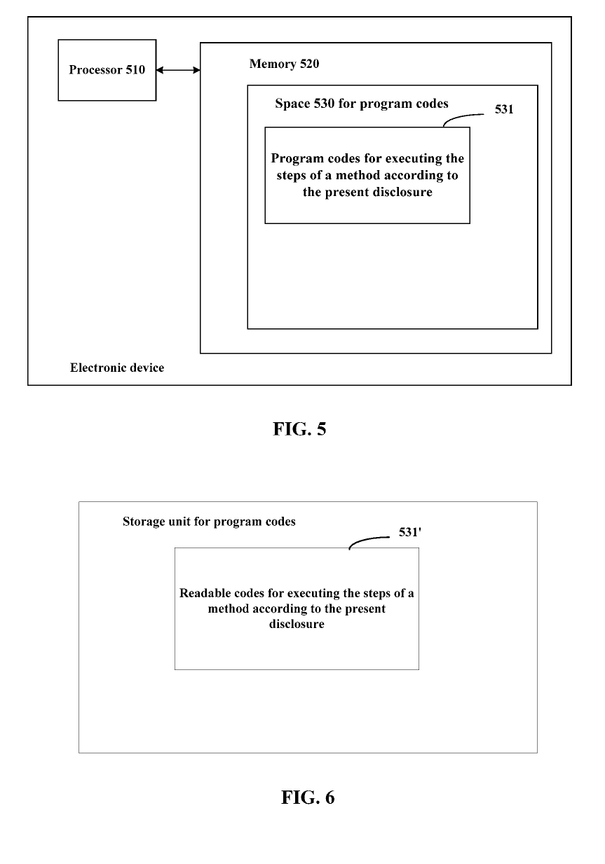

For example, FIG. 5 illustrates a block diagram of an electronic device for executing the method according the disclosure. Traditionally, the electronic device includes a processor 510 and a computer program product or a computer readable medium in form of a memory 520. The memory 520 could be electronic memories such as flash memory, EEPROM (Electrically Erasable Programmable Read-Only Memory), EPROM, hard disk or ROM. The memory 520 has a memory space 530 for executing program codes 531 of any steps in the above methods. For example, the memory space 530 for program codes may include respective program codes 531 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 6. The memory cells may be provided with memory sections, memory spaces, etc., similar to the memory 520 of the server as shown in FIG. 5. The program codes may be compressed for example in an appropriate form. Usually, the memory cell includes computer readable codes 531′ which can be read for example by processors 510. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

The embodiments of the present disclosure are described with reference to the flow diagrams and/or the block diagrams of the method, the terminal device (system), and the computer program product according to the embodiments of the present disclosure. It should be appreciated that computer program commands may be adopted to implement each flow and/or block in each flow diagram and/or each block diagram, and the combination of the flows and/or the blocks in each flow diagram and/or each block diagram. These computer program commands may be provided to a universal computer, a special purpose computer, an embedded processor or a processor of another programmable data processing terminal equipment to generate a machine, such that the commands executed by the computer or the processor of another programmable data processing terminal equipment create a device for implementing functions specified in one flow or multiple flows of each flow diagram and/or one block or multiple blocks of each block diagram.

These computer program commands may also be stored in a computer readable memory that is capable of guiding the computer or another programmable data processing terminal equipment to work in a specified mode, such that the commands stored in the computer readable memory create a manufacture including a command device for implementing functions specified in one flow or multiple flows of each flow diagram and/or one block or multiple blocks of each block diagram.

Further, these computer program commands may be loaded on the computer or another programmable data processing terminal equipment, such that a series operation steps are executed on the computer or another programmable data processing terminal equipment to generate processing implemented by the computer; in this way, the commands executed on the computer or another programmable data processing terminal equipment provide steps for implementing functions specified in one flow or multiple flows of each flow diagram and/or one block or multiple blocks of each block diagram.

The video playing method and the video playing device provided by the present disclosure are introduced above in detail. In this text, specific examples are utilized to elaborate the principle and the embodiments of the present disclosure. The above descriptions of the embodiments are merely intended to help understanding the method of the present disclosure and the core concept thereof. Meanwhile, for a person ordinarily skilled in the art, alterations may be made to the specific embodiments and the application scope according to the concept of the present disclosure. In conclusion, the contents of this description should not be understood as limitations to the present disclosure.

The electronic device in embodiment of the present disclosure may have various types, which include but are not limited to:

(1) a mobile terminal device having the characteristics of having mobile communication functions and mainly aiming at providing voice and data communication. This type of terminals include mobile terminals (such as iPhone), multi-functional mobile phones, functional mobile phones and lower-end mobile phones, etc.;

(2) an ultra portable personal computing device belonging to personal computer scope, which has computing and processing ability and has mobile internet characteristic. This type of terminals include personal digital assistant (PDA) devices, mobile internet device (MID) devices and ultra mobile personal computer (UMPC) devices, such as iPad;

(3) a portable entertainment device which may display and play multi-media contents. This type of devices include audio players, video players (such as an iPod), handheld game players, e-books, intelligent toy, and portable vehicle-mounted navigation devices;

(4) a server providing computing service, the server includes a processor, a hard disk, a memory and a system bus. The server has the same architecture as a computer, whereas, it is required higher in processing ability, stableness, reliable ability, safety, expandable ability, manageable ability etc. since the server is required to provide high reliable service;

(5) other electronic device having data interaction functions.

The device embodiment(s) described above is (are) only schematic, the units illustrated as separated parts may be or may not be separated physically, and the parts shown in unit may be or may not be a physical unit. That is, the parts may be located at one place or distributed in multiple network units. A skilled person in the art may select part or all modules therein to realize the objective of achieving the technical solution of the embodiment. Through the description of the above embodiments, a person skilled in the art can clearly know that the embodiments can be implemented by software and necessary universal hardware platforms, or by hardware. Based on this understanding, the above solutions or contributions thereof to the prior art can be reflected in form of software products, and the computer software products can be stored in computer readable media, for example, ROM/RAM, magnetic discs, optical discs, etc., including various commands, which are used for driving a computer device (which may be a personal computer, a server or a network device) to execute methods described in all embodiments or in some parts of the embodiments.

Finally, it should be noted that the above embodiments are merely used to describe instead of limiting the technical solution of the present disclosure; although the above embodiments describe the present disclosure in detail, a person skilled in the art shall understand that they can modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. A video playing method, comprising:
at an electronic device:
a player in a playing page obtaining a storage address of a target video when the playing page is loaded;
determining a playing component for the target video by analyzing the storage address;
obtaining a data packet of the target video according to the storage address;
using the playing component to process the obtained data packet to generate buffered data;
playing the target video according to the buffered data if a playing command is detected after the completion of loading the playing page.

2. The method according to claim 1, further comprising:
pre-activating the player in the playing page after a command of entering the page is received.

3. The method according to claim 2, wherein the step of the player in a playing page obtaining a storage address of a target video when the playing page is loaded comprises the following operations:
determining the target video according to video information locally buffered or in the page command when the playing page is loaded;
the player obtaining the storage address of the target video that is transmitted by the playing page.

4. The method according to claim 3, wherein the step of determining a playing component for the target video by analyzing the storage address comprises:
analyzing the storage address to determine a video format of the target video;
creating the playing component required for playing the target video according to the video format.

5. The method according to claim 1, wherein the playing component comprises a demultiplexer and a decoder;
the step of using the playing component to process the obtained data packet to generate buffered data comprises:
using the demultiplexer to separate the data packet to generate a video data stream and an audio data stream;
using the decoder to decode the video data stream and the audio data stream to generate the buffered data.

6. The method according to claim 2, wherein the playing component comprises a demultiplexer and a decoder;
the step of using the playing component to process the obtained data packet to generate buffered data comprises:
using the demultiplexer to separate the data packet to generate a video data stream and an audio data stream;
using the decoder to decode the video data stream and the audio data stream to generate the buffered data.

7. An electronic device comprising:
at least a processor; and
a memory communicably connected with the at least one processor for storing instructions executable by the at least one processor, wherein execution of the instructions by the at least one processor causes the at least one processor to:
enable a player in a playing page to obtain a storage address of a target video when the playing page is loaded;
determine a playing component for the target video by analyzing the storage address;
obtain a data packet of the target video according to the storage address;
use the playing component to process the obtained data packet to generate buffered data;
play the target video according to the buffered data if a playing command is detected after the completion of loading the playing page.

8. The device according to claim 7, wherein execution of the instructions by the at least one processor causes the at least one processor to further:
pre-activate the player in the playing page after a command of entering the page is received.

9. The device according to claim 8, wherein enable a player in a playing page to obtain a storage address of a target video when the playing page is loaded comprises:
determining the target video according to video information locally buffered or in the page command when the playing page is loaded;
enabling the player to obtain the storage address of the target video that is transmitted by the playing page.

10. The device according to claim 8, wherein determining a playing component for the target video by analyzing the storage address comprises:
analyzing the storage address to determine a video format of the target video;
creating the playing component required for playing the target video according to the video format.

11. The device according to claim 6, wherein the playing component comprises a demultiplexer and a decoder; use the playing component to process the obtained data packet to generate buffered data comprises:
using the demultiplexer to separate the data packet to generate a video data stream and an audio data stream;
decoding the video data stream and the audio data stream by using the decoder to generate the buffered data.

12. The device according to claim 7, wherein the playing component comprises a demultiplexer and a decoder; use the playing component to process the obtained data packet to generate buffered data comprises:
using the demultiplexer to separate the data packet to generate a video data stream and an audio data stream;
decoding the video data stream and the audio data stream by using the decoder to generate the buffered data.

13. A non-transitory computer readable medium storing executable instructions that, when executed by an electronic device, cause the electronic device to:
obtain a storage address of a target video by a player in a playing page when the playing page is loaded;
determine a playing component for the target video by analyzing the storage address;
obtain a data packet of the target video according to the storage address;
use the playing component to process the obtained data packet to generate buffered data;
play the target video according to the buffered data if a playing command is detected after the completion of loading the playing page.

14. The non-transitory computer readable medium according to claim 13, wherein the electronic device is further caused to:
pre-activate the player in the playing page after a command of entering the page is received.

15. The non-transitory computer readable medium according to claim 14, wherein obtain a storage address of a target video by a player in a playing page when the playing page is loaded comprises the following operations:
determining the target video according to video information locally buffered or in the page command when the playing page is loaded;
the player obtaining the storage address of the target video that is transmitted by the playing page.

16. The non-transitory computer readable medium according to claim 15, wherein determine a playing component for the target video by analyzing the storage address comprises:
analyzing the storage address to determine a video format of the target video;
creating the playing component required for playing the target video according to the video format.

17. The non-transitory computer readable medium according to claim 13, wherein the playing component comprises a demultiplexer and a decoder;
use the playing component to process the obtained data packet to generate buffered data comprises:
using the demultiplexer to separate the data packet to generate a video data stream and an audio data stream;
using the decoder to decode the video data stream and the audio data stream to generate the buffered data.

18. The non-transitory computer readable medium d according to claim 14, wherein the playing component comprises a demultiplexer and a decoder;
use the playing component to process the obtained data packet to generate buffered data comprises:
using the demultiplexer to separate the data packet to generate a video data stream and an audio data stream;
using the decoder to decode the video data stream and the audio data stream to generate the buffered data.
